(19) United States
(12) Patent Application Publication
(10) Pub. No.: US 2013/0197675 A1
(43) Pub. Date: Aug. 1, 2013

(54) PERFORMANCE ANALYTICS BASED ON HIGH PERFORMANCE INDICES

(71) Applicants: Brian F. McCarthy, Atlanta, GA (US); Roxana Dubash, Naperville, IL (US); Gerald Brockman, Orono, MN (US); Julio J. Hernandez, Atlanta, GA (US); Frode Huse Gjendem, Barcelona (ES)

(72) Inventors: Brian F. McCarthy, Atlanta, GA (US); Roxana Dubash, Naperville, IL (US); Gerald Brockman, Orono, MN (US); Julio J. Hernandez, Atlanta, GA (US); Frode Huse Gjendem, Barcelona (ES)

(73) Assignee: Accenture Global Services Limited, Dublin 4 (IE)

(21) Appl. No.: 13/642,764

(22) PCT Filed: Apr. 22, 2011
(86) PCT No.: PCT/US11/33633

§ 371 Date: Nov. 27, 2012

Related U.S. Application Data
(60) Provisional application No. 61/326,803, filed on Apr. 22, 2010.

(51) Int. Cl. G05B 13/02

(52) U.S. Cl. CPC G05B 13/021
USPC 700/28

(57) ABSTRACT

A performance optimization system includes a superior performance engine identifying high performance entities and determining benchmarks from data captured for the high performance entities. The benchmarks correspond with factors in the indices. The indices include a growth index, an operational excellence index, and an enterprise management index. A data capture module captures data related to the factors for an entity. An optimization engine determines values for the factors from the data captured for the entity, and compares the values with the benchmarks to identify underachieving factors. Estimated performance for the entity is calculated based on modifications to the underachieving factors.

### BACKGROUND

Businesses typically analyze their business processes periodically to discover efficient use of their business units, financial, human, and material resources. Businesses may utilize key performance indicators (KPIs), or performance metrics, to monitor efficiency of projects and employees against operational targets. These metrics and KPIs may be used to assess the present state of the business and to prescribe a course of action. Examples of metrics and KPIs include: new customers acquired; status of existing customers; attrition of customers; turnover generated by segments of customers; outstanding balances held by segments of customers and terms of payment; collection of bad debts within customer relationships; demographic analysis of individuals (potential customers) applying to become customers, and the levels of approval, rejections and pending numbers; and profitability of customers by demographic segments and segmentation.

The businesses may have business intelligence (BI) systems or business process management (BPM) systems that use the metrics and KPIs to assess the present state of the business and to prescribe a course of action. Regardless of the type of analysis the BI or BPM systems perform, the systems must acquire metrics and KPIs that are consistent, correct, and timely-available. Furthermore, despite the great benefits many BI and BPM systems provide, these systems are only as powerful as the metrics and KPIs used to benchmark business performance.

Unfortunately, there is a disconnect in traditional BI and BPM systems between the financial performance metrics businesses use in analyzing business performance and the ability to create and sustain high performance results in their execution over time. This disconnect arises because most businesses take an internal approach to evaluating their business performance using performance metrics such as Earnings per Share (EPS), Return on Net Assets (RONA), Earnings Before Interest, Taxes, Depreciation, and Amortization (EBITDA), Return on Investment Capital (ROIC), Economic Value Added (EVA), Cash Flow Return on Investment (CFROI), and the like. These metrics only provide analysis of a company's current value, and thus, may not be as beneficial for determining future value or determining how to adjust business practices going forward to improve future value.

### SUMMARY

According to an embodiment, a performance optimization system includes a superior performance engine identifying high performance entities and determining benchmarks from data captured for the high performance entities. The benchmarks correspond with factors in the indices. The indices include a growth index, an operational excellence index, and an enterprise management index. A data capture module captures data related to the factors for an entity. An optimization engine determines values for the factors from the data captured for the entity, and compares the values with the benchmarks to identify underachieving factors. Estimated performance for the entity is calculated based on modifications to the underachieving factors. One or more components of the system may include hardware or machine readable instructions executed by a computer system.

According to another embodiment, a method of estimating performance for an entity based on high performance indices comprises identifying high performance entities; determining benchmarks from data captured for the high performance entities, wherein the benchmarks correspond with factors in each of the indices comprised of a growth index, an operational excellence index, and an enterprise management index; capturing data related to the factors for the entity; determining values for the factors from the data captured for the entity; comparing the values with the benchmarks to identify one or more underachieving factors; and calculating an estimated performance for the entity based on modifications to the underachieving factors. The method may be embodied as computer readable instructions stored on a non-transitory computer readable medium that when executed by a computer system perform the method.

### BRIEF DESCRIPTION OF DRAWINGS

The embodiments of the invention will be described in detail in the following description with reference to the following figures.

FIG. 1 illustrates a performance optimization system, according to an embodiment;

FIGS. 2-4 illustrate high performance indices, according to embodiments;

FIG. 5 illustrates a chart for identifying high performance entities, according to an embodiment;

FIG. 6 illustrates the chart with data points for entities, according to an embodiment;

FIG. 7 shows a path of a company X through lifecycle stages in the chart, according to an embodiment;

FIG. 8 illustrates a flow chart of a method for determining benchmarks and weightings for factors in the high performance indices, according to an embodiment;

FIG. 9 illustrates a flow chart of a method for benchmarking and conducting “what-if” analysis based on the benchmarking, according to an embodiment;

FIG. 10 illustrates a flow chart of a method for identifying data most likely to represent events that may impact performance; and

FIG. 11 illustrates a computer system that may be used for a platform for the system shown in FIG. 1, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Furthermore, different embodiments are described below. The embodiments may be used or performed together in different combinations.

1. Overview

A performance optimization system, according to an embodiment of the invention, determines and analyzes relevant factors from high performance indices relating to growth, operation excellence and enterprise management. Each of the high performance indices includes factors determined to have causal relationships to high performance in terms of value and growth. The system uses the factors to perform analytics, including estimating performance-related metrics to improve future performance for companies.

Furthermore, the system provides a technical solution to the problem of identifying performance metrics to improve that will improve the performance of the entity. The technical solution encompasses storing causal relationships for factors predetermined to have a positive impact on high performance entities, and using these relationships to run simulations on modifications to the performance metrics to determine whether the overall performance of the entity is improved. This is referred to as “what-if” analysis. Furthermore, functionality is provided to identify underachieving factors whereby improvement in those factors is likely to improve the performance of the entity. Thus, the system significantly increases the speed and efficiency in achieving improved performance for the entity. In addition, the system provides an improved man-machine interaction that includes an interface for running “what-if” analysis and also provides an interface for viewing and identifying high performance entities, determining lifecycle stages and for visualizing the performance and current stage for an entity.

2. System

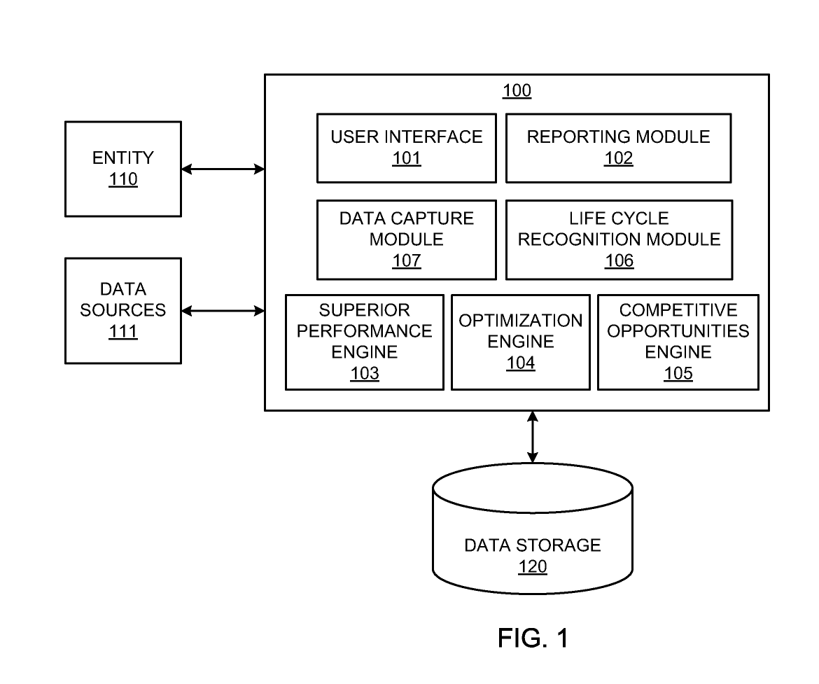

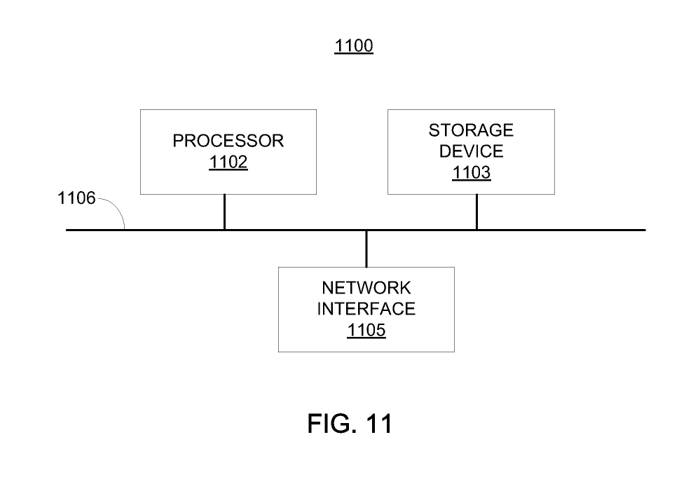

FIG. 1 illustrates a performance optimization system 100, according to an embodiment. The performance optimization system 100 includes user interface 101, reporting module 102, superior performance engine 103, optimization engine 104, competitive opportunities engine 105, and lifecycle recognition module 106. The components of the system 100 may be hardware, software or a combination of hardware and software. The software may comprise computer readable instructions executed by a computer system and stored on a non-transitory computer readable medium, as is further described with respect to FIG. 11.

A data storage 120 includes a data storage system that stores data organized in a manner that allows desired data to be easily stored and retrieved. For example, the data storage 102 may include a relational database, or may be part of an online analytical processing (OLAP) system for retrieving data, or may include another type of data storage system. The data storage 120 may be included in the system 100 or be an external system connected directly or via a network.

The data storage 120 stores any data that may be used by the system 100. Examples of the data are described in further detail below and may include but are not limited to the high performance indices, the factors in the indices, data or measurements for the factors, benchmarks derived from data from high performing entities, weightings for factors, information categorized based on industry type or life cycle stage, and data from entity 110 and data sources 111.

The entity 110 may be a business/company, a government entity, any type of organization, an individual or group of individuals, etc. The entity 110 may be any entity with responsibility and/or accountability for economic performance. The entity 110 is an entity that may use the system 100 to estimate future success of the entity 110 and to identify business practices to adjust to realize improved success.

The data sources 111 may be public or private data sources that provide information related to the high performance indices or determining benchmarks or weightings for factors in the indices. The data sources 111 may also provide information related to exogenous factors that may impact value or growth for the entity 110. The information may include information related to potential competitive opportunities that may be exploited by the entity to improve performance. The entity 110 and the data sources 111 may be connected to the system 100 via a network or another communications channel.

The user interface 101 may be a graphical user interface (GUI) that allows users to input information and receive information from the system 100. For example, the entity 110 may input information related to the industry type, lifecycle stage, and high performance indices via the user interface 101. The entity 110 may also input information via the user interface 101 describing different scenarios to estimate future value for the different scenarios and view results of simulating the different scenarios, which may include the estimated future values. Also, the entity 110 may view reports generated by the reporting module 102, which may include benchmark analysis, and the generation of other reports that describe the future value and factors for estimating the future value. The reports may be viewable in the GUI and may be downloadable in a predetermined format.

The superior performance engine 103 identifies high performance entities from the data provided by the data sources 111. The superior performance engine 103 identifies measurements and values for factors in the high performance indices and may use this information to determine benchmarks and weightings for the factors. The superior performance engine 103 also identifies the factors that may be most relevant for particular industries and for different stages of a business lifecycle. This information may be used to determine different weights for factors and/or to select different factors that are relevant to an entity for calculating future value and for determining future value estimates for different scenarios. The information determined by the superior performance engine 103 and the other components of the system 100 may be stored in the data storage 120.

The optimization engine 104 identifies factors and weightings for the entity 110 and calculates future value from the factors. This information may be based on the findings from the superior performance engine 103. The optimization engine performs benchmarking for the factors of the entity 110, for example, using the benchmarks determined by the superior performance engine 103 or using other benchmarks. The optimization engine 104 identifies factors that are underachieving based on the benchmarking. Business practices or other practices associated with the underachieving factors may be identified for improvement to improve the future value for the entity 110. The optimization engine 104 also performs “what-if analysis” that allows different scenarios to be simulated to determine how the scenario impacts performance. For example, the entity 110 may enter through the user interface 101 changes to values for one or more factors in the high performance indices. The optimization engine 104 calculates performance based on the changed values. The performance may include current value, future value, etc. For example, if a factor is identified as being underachieving based on the benchmarking, the entity 110 may adjust a value for the factor to determine how much improvements to performance the adjustment yields. This procedure may be performed to identify a set of factors to improve to maximize performance given one or more constraints, and then to modify business practices to achieve the changes to the set of factors.

The competitive opportunities module 105 identifies data from the data sources 111 that may be related to opportunities for the entity 110. The data may be captured and normalized by the data capture module 107. For example, the data capture module 107 captures data from the data sources 111 and the entity 110. The data capture module 107 may execute or submit queries related to the entity 110 or related to the industry for the entity 110. The captured data may be normalized to a particular format and stored in the data storage 120. The competitive opportunities module 105 may filter the data related to the entity 110 for identifying events or trends that may impact the performance of the entity 110 and report the events or trends, for example, via the user interface 101.

The lifecycle recognition module 106 determines the current lifecycle stage of the entity 110 based on information gathered from the entity 110 and benchmark information for different stages of the lifecycle. Factors impacting performance of an entity may change or their weightings may change over the course of the lifecycle and based on industry and exogenous factors over time. The superior performance engine 103 and the optimization engine 104 may determine current value and future value throughout the stages of the lifecycle. For a business, the lifecycle may begin with failing to generate economic profit but inspiring expectations from the market for greater value in the future. In a second stage, as the business grows, it typically falls further behind in current value but rises in future value in anticipation of improving future performance. With growth and maturity, the business moves toward a position of generating positive economic profit in a third stage. This pattern may proceed until a fourth stage which may include a “watershed moment” in which high performers diverge from others that are drawn back to economic equilibrium as market forces influence performance.

The lifecycle recognition module 106 may compare values for factors in the high performance indices for the entity 110 to data from other entities in the same industry and from lifecycle stage benchmarks to identify the current lifecycle of the entity 110. The current stage may be stored in the data storage 120 and used to identify factors and weightings for estimating performance.

3. High Performance Indices

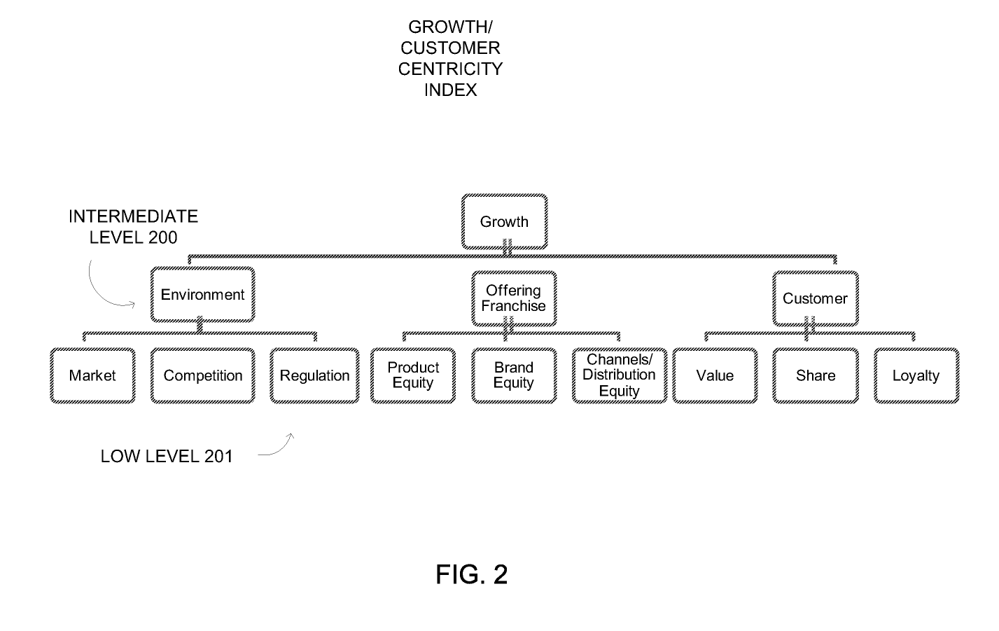

FIGS. 2-4 show the high performance indices. The high performance indices are comprised of factors that are drivers for performance. The high performance indices are determined from extensive analysis of top performing companies and the drivers that may have been used to measure their performance. The indices are represented as hierarchies with low-level and intermediate factors at different levels of the hierarchies.

FIG. 2 shows the growth index. The growth index is also referred to as the customer centricity index. The growth index represents factors impacting growth of the entity and may include details associated with experience integration, customer personalization, customer engagement, offerings/supply chain, workforce, channels, and customer strategy. The growth index includes an intermediate level 200 and a low level 201. The intermediate level 200 is comprised of intermediate factors including environment, offering franchise, and customer.

The environment is related to the operating environment for the entity. The low-level factors under environment are market, competition and regulation. Market is associated with the stability and viability of the market. Competition is related to identifying the competitors, the strength of the competitors and whether the competitors are competing directly with our products. Regulation is associated with regulations promulgated by regulatory bodies that the entity may have to comply with to do business in the market place.

Offering franchise is related to the overall offerings, such as products and services, of the entity. The low-level factors under offering franchise are product equity, brand equity and channels/distribution equity. Product equity is associated with the portfolio or products, new products, and lifecycle management of products. Brand equity is associated with the strength of the brand and may include brand penetration and brand usage. Channel distribution is associated with the strength of the distribution channels for the products. This may include terms of share of distribution channels, expansion into new channels, cost of distribution, etc.

The low-level factors under customer are value, share and loyalty.

Value is associated with the value a customer places on the product. Share describes the hold on the market and may include mind share (e.g., consumer awareness of the product) and spending share or market share. Loyalty is associated with the willingness of customers to stick with a brand or specific products and make recommendations to other people to purchase the products.

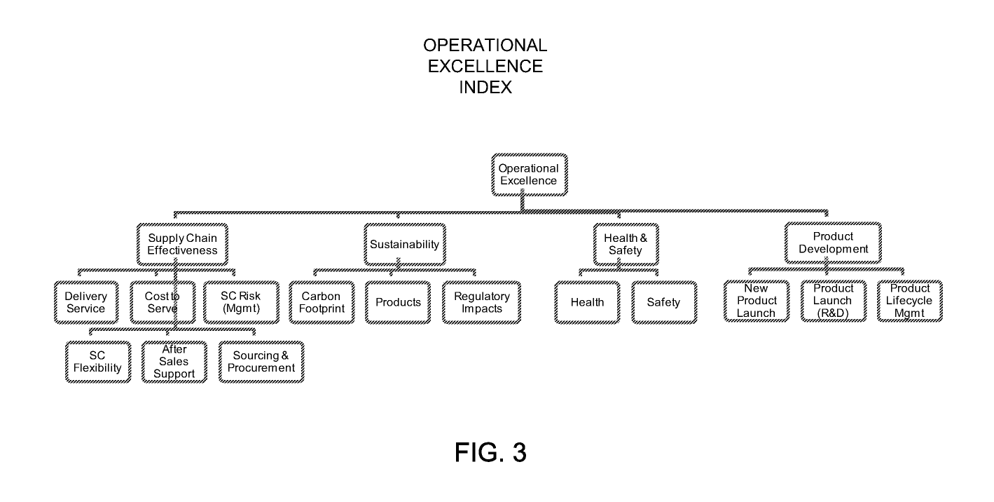

FIG. 3 shows the operation excellence index. Operational excellence is associated with the standards and operations of the entity around the organization supply chain. Operational excellence may focus on the needs of the customers and employees. The intermediate factors include supply chain effectiveness, sustainability, health and safety, and product development.

Supply chain effectiveness is associated with the procedures and metrics for the supply chain. The low level factors under supply chain effectiveness include delivery service, cost to serve, supply chain risk management, supply chain flexibility, after sales support, and sourcing and procurement. Delivery service is the service level at the next supply chain node or at one of the downstream nodes. It may be measured in terms of percentage of orders fulfilled on time and in full or the percentage of total demand met. Cost to serve in the context of supply chain management can be used to show how costs are consumed throughout the supply chain. Supply chain risk management attempts to reduce supply chain vulnerability including identifying and analyzing the risk of failure points within the supply chain. Supply chain flexibility determines how fast a supply chain could detect and respond to issues and opportunities and adapt to new strategies. After sales support describes the ongoing relationship with the customer, which may include where services are rendered to the customer throughout the product life cycle to the end of life. This type of support typically includes warranty, upgrade and repair services. Sourcing and procurement refers to a number of procurement practices, aimed at finding, evaluating and engaging suppliers of goods and services. Sourcing typically focuses on maximizing TVO (total value of ownership) or traditionally cost focused TCO (total cost of ownership).

The low-level factors under sustainability include carbon footprint, products, and regulatory impacts. A carbon footprint is the total set of greenhouse gases (GHG) emissions caused by an organization, event or product. For simplicity of reporting, it is often expressed in terms of the amount of carbon dioxide, or its equivalent of other GHGs, emitted. Product sustainability refers to the overall design and management of the product such as designing it to be built by maximizing use of recycled materials. Regulatory impact may include an analysis comprising a systemic approach to critically assessing the positive and negative effects of proposed and existing regulations and non-regulatory alternatives.

The health and safety low-level factors are associated with the health and safety of the employees, customers, suppliers employees and environment in general. The low-level factors under product development are new product launch, product launch, and product lifecycle management. The new product launch is the extent to which the new product attains its pre-defined objective (e.g., market capture, sales in first quarter, etc) as attributed to the launch exercise. Product launch includes processes crossing research and development, marketing, sales, supply chain, manufacturing and suppliers corresponding processes. This focuses on an organizations ability to develop new products and as such focuses on innovation and change. Product lifecycle management is the process of managing the entire lifecycle of a product from its conception, through design and manufacture, to service and disposal. Product lifecycle management integrates people, data, processes and business systems and provides a product information backbone for companies and their extended enterprise.

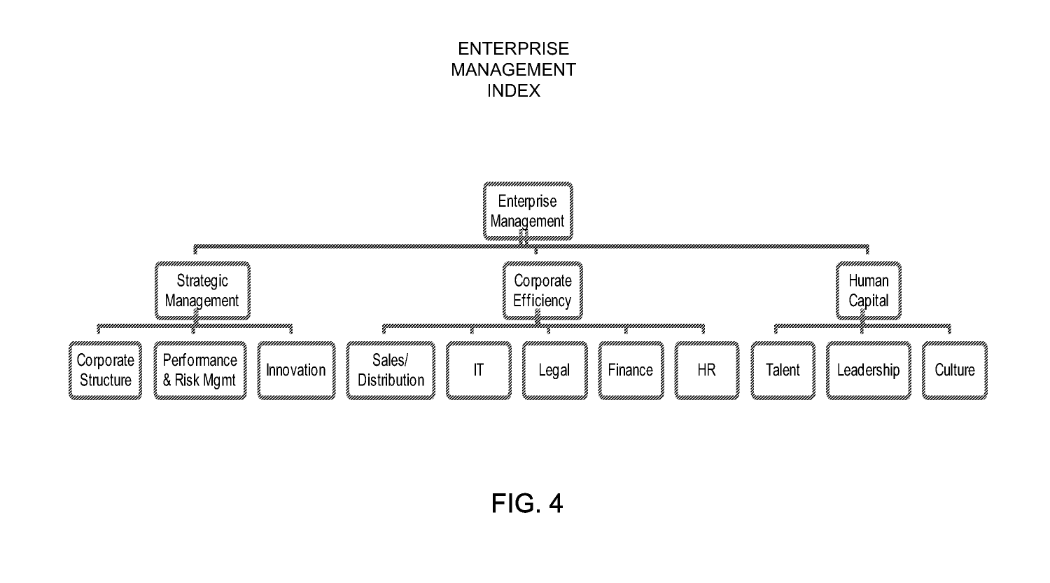

FIG. 4 shows the enterprise management index. Enterprise management is associated with the efficiency of operations for the entity. The intermediate factors include strategic management, corporate efficiency and human capital.

Strategic management is associated with processes that evaluate and control the business and the industries in which the business is involved. The low-level factors under strategic management are corporate structure, performance and risk management, and innovation. Corporate structure may be associated with the ability of the corporate structure to respond to competitive threats and implementation of strategies. Performance and risk management is associated with understanding the processes in place to measure performance and risk and abilities to respond to low performance and risks. Innovation may include evaluating whether the entity is innovating, and incorporating innovation into new products or business practices.

Corporate efficiency is associated with the efficiency of business units in the organization. The units may include sales and distribution, information technology, legal, finance, and human resources.

The low-level factors under human capital are talent, leadership and culture. These factors may be associated with evaluating and maintaining high quality talent and leadership, and creating and maintaining a desired culture within the organization.

Scoring may be performed for the factors in each of the indices. For example, the low-level factors under environment are market, competition and regulation. Metrics for each of these factors are measured or derived from measurements. An example for a metric for market may include % increase or decrease in consumer sales over a previous period, or unemployment. The metrics may be gathered from the data sources 111 shown in FIG. 1. Weightings for each of the low-level factors are determined and the metrics for each of the low-level factors are weighted. The weighted metrics may be normalized to a scale, such as between 0 and 10. The normalized values may be summed to determine a score for the intermediate-level metric, which is environment in this example. A score is calculated for each intermediate level factor. Each score may be weighted and then the intermediate level scores are summed to determine a score for growth. Weights may be based on lifecycle stage and other factors. The scores, for example, are calculated by the optimization engine 104 to identify underachieving factors that may be improved to achieve better performance.

Scoring may be performed for each index, such as described above by way of example with respect to the growth index. Furthermore, factors in the indices may change over time. Analysis of key value drivers for top performing companies may be periodically performed over time. The analysis may identify new factors that are determined to have a causal relationship to performance for the top performers. The new factors may be introduced into the indices and other factors may be removed based on the on-going analysis. In one example, subsequent analysis of key value drivers for top performers in a particular industry may identify new factors for the industry determined to drive performance. These new factors may be included in an index. Also, in other instances factors may be removed from an index if they are subsequently determined to have less of an impact on performance.

4. High Performance

Performance for an entity may be determined from one or more measures related to return on investment (ROI), value, growth, etc. High performance is related to the entity's ability to maximize the present value of its future cash flows. High performance may be determined from current value and future value of the entity. Current Value is the present value of NOPLAT, calculated as follows: CV=NOPLAT/WACC or CV=EP/WACC+IC. Future value is the difference between the market's valuation of the entity, for example represented by its enterprise value (EV), and its current value. A positive future value reflects the market's expectations that the entity will perform better in the future than it is today. For instance, in the late 1990s (the “dot-com days”) there were many new ventures with quite high valuations that were generating negative cash flows. Clearly, investors were betting on significant improvements in future performance.

In one embodiment, future value premium (FVP) may be used to determine whether an entity is a high performer. Entities that have a future value greater than or equal to a future value benchmark, for example, based on the industry's average are deemed to have a FVP. Thus, the future value premium is calculated as a function of the peer group being analyzed. The future values may be normalized to a standard for comparison, and the FVP of an entity may be defined based on a comparison of the entity's normalized future value to a future value benchmark, which may be the normalized future values of entities in a defined peer group. FVP for an entity is the FV of the entity minus the future value benchmark.

Examples of calculating the future value benchmark are described below. In the examples below, the entity is a company. Other methods for determining the future value benchmark may be used. In the examples described below, EV is the enterprise value, CV is the current value, FV is the future value, and IC is the invested capital. EV, CV, FV and IV are now described followed by a description of the examples of calculating the future value benchmark. The total market value of the company (MV) may be defined as the company's market value of equity plus the market value of the debt. EV=MV less excess cash and can be decomposed into CV and FV. The CV represents the current value of the company. As indicated in the equation for CV above, CV is influenced by the company's Net Operating Profits Less Adjusted Taxes (NOPLAT), capital, and Weighted Average Cost of Capital (WACC). Return on Invested Capital (ROIC) =NOPLAT/IC and EP=(ROIC−WACC)*IC. The FV represents the future value of the company, and can be calculated by subtracting CV from EV, such that FV=EV−CV. The FV is influenced by capital and the WACC. The capital may include both balance sheet and off-balance sheet components, and income may influence capital as well as NOPLAT. Invested capital represents the total cash investment made in the company for example by owners/shareholders and debt holders. These calculations are further described in U.S. Pat. No. 7,778,910, entitled Future Value Drivers, which is incorporated by reference in its entirety.

Examples of the future value benchmark are now described. In one example, the future value benchmark is sum(Peer Group, FV)/sum(Peer Group, IV). The Peer Group may be an industry peer group of high performers for the entity for which FVP is being determined. Sum(Peer Group, EV) and sum(Peer Group, IV) are the sum of EVs and the sum of IVs, respectively, for the members of the Peer Group for the entity. Another example of the future value benchmark is the median FVs of the peer group, for example, based on the normalized values of the peer group's FVs.

5. Chart Illustrating Economic Profit and Future Value

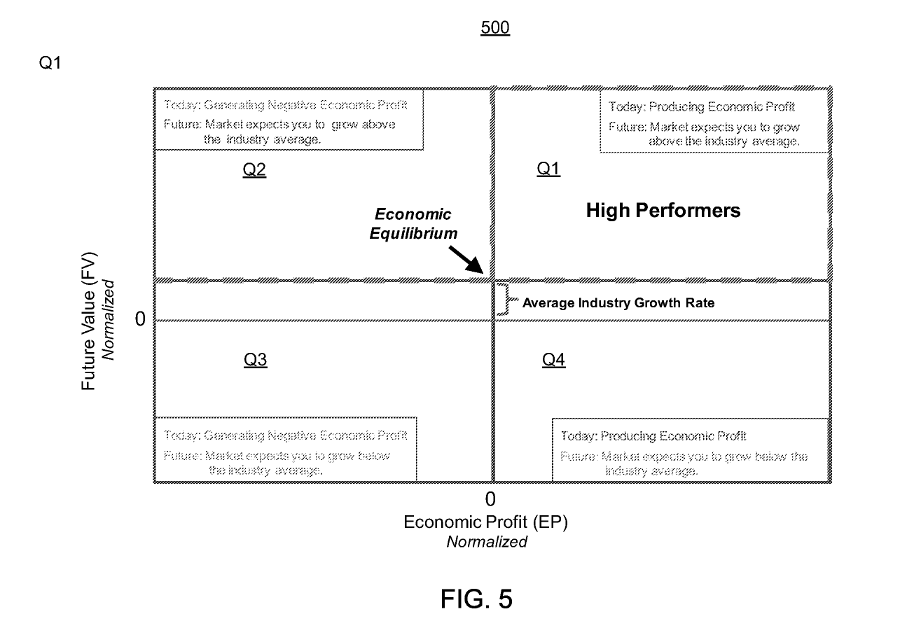

FIG. 5 illustrates a chart 500 representing economic profit and future value for entities. The economic profit and future value are represented on the X and Y-axes, respectively. The chart 500 includes four quadrants Q1-Q4. Entities falling in Q1 are the high performers. The high performers produce an economic profit today and the market expects the entities to grow above the industry average. Entities falling in Q2 have a negative economic profit today and the market expects the entities to grow above the industry average. Companies that fall in Q2 may be referred to as “Emerging/Turnaround”, the situation in which many of the dot-coms found themselves in the heady early days of the Internet. Entities falling in Q3, referred to as “graveyard”, have a negative economic profit and the market expects them to grow below the industry average. Entities falling in Q4 produce an economic profit today and the market expects the entities to to grow below the industry average. The entities in Q4 may be referred to as cash cows and the market is perceiving them as having limited growth potential relative to where they are today.

Q1 represents the area where high performers would fall. As indicated above, high performers are entities having a future value premium, which are entities having a future value greater than or equal to the future value benchmark. High performers may include entities producing economic profit today and generating market expectations that they will not only perform better in the future but at a rate that exceeds a market-implied industry average growth rate. In one example, the market-implied industry average growth rate is determined based on 2009 data for the consumer discretionary industry sector. The 2009 current performance and market valuations indicate a 4.4 percent perpetuity growth rate. In this example, if a company is above that threshold rate and delivering economic profit today, it is a high performer.

Also shown in the chart 500 is the economic equilibrium where industry dynamics are completely balanced throughout the value-chain allowing the entity to generate returns in line with its cost of capital (no more and no less). This would be represented as a zero value on the x-axis of Economic Profit. Furthermore, economic equilibrium would anticipate a market-implied average growth in the future.

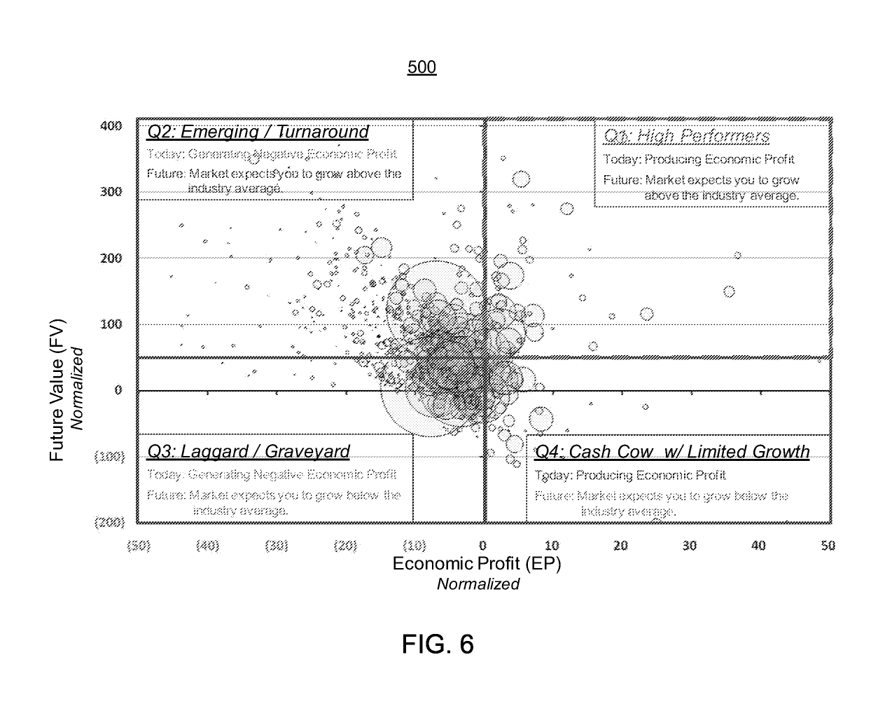

FIG. 6 illustrates the chart 500 with data points for entities. Both the economic profit and future value components on the X and Y-axes have been normalized to account for the size of the company. The size of the company is represented by the size of the bubbles as defined by the amount of each company's invested capital base.

The chart 500 allows a user viewing the chart or the engine 103 shown in FIG. 1 to easily identify those companies in any given industry that have high performance in terms of economic profit and the market's assessment of future value. The high performers are candidates for more in-depth research into the factors, which may include factors from the high performance indices, that have enabled them to achieve and sustain high performance.

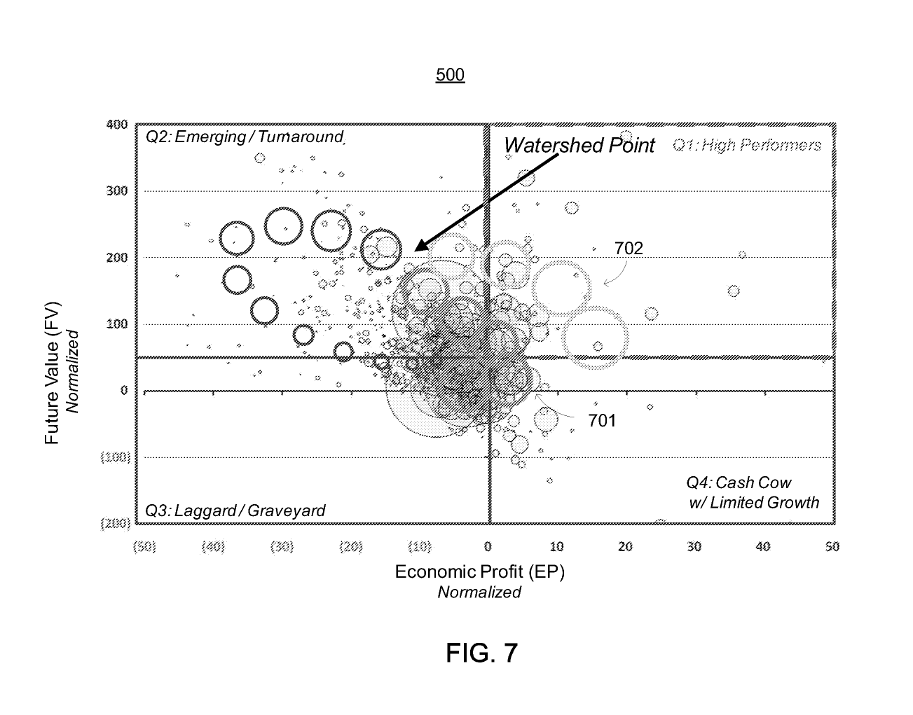

The chart 500 allows a user viewing the chart or the lifecycle recognition module 106 shown in FIG. 1 to identify the lifecycle stage of an entity. FIG. 7 shows the typical path of a company X through the lifecycle stages over time. The different lifecycle stages may be represented in the quadrants Q1-Q4. The lifecycle begins in Q2 with failing to generate economic profit but inspiring expectations from the market for greater value in the future. In a second stage, as the business grows, it typically falls further behind in current value but rises in future value in anticipation of improving future performance; still remaining in Q2. With growth and maturity, company X moves toward a position of generating positive economic profit in a third stage; still remaining in Q2 but getting closer to Q1 or Q4. This pattern may proceed until a fourth stage which may include a “watershed moment” in which high performers diverge from others that are drawn back to economic equilibrium as market forces influence performance. Path 701 shows a breakout into Q4 in the fourth stage. Path 702 shows an alternative path for company X with a breakout towards equilibrium and into Q1 and then Q2.

6. Methods

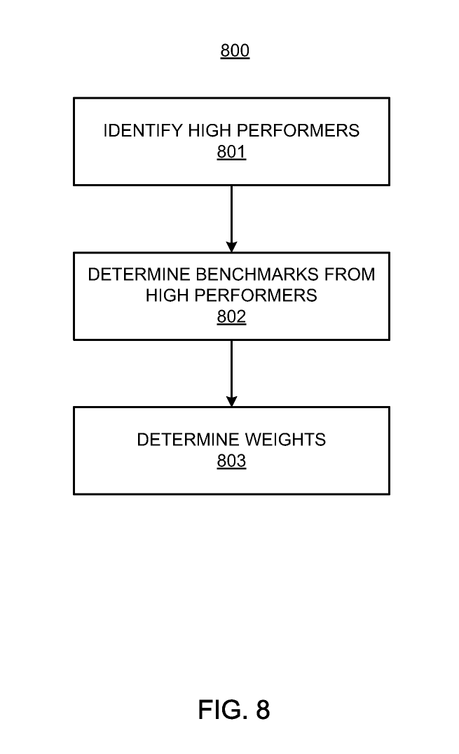

FIG. 8 illustrates a flowchart of a method 800 for identifying high performers and determining benchmarks and weightings for factors in the high performance indices. The method 800 and other methods described herein are described with respect to the system 100 by way of example and not limitation. The methods may be performed by other systems.

At step 801, high performers are identified. High performers are high performance entities. For example, the superior performance engine 103 identifies high performers based on data captured from the data sources 111 for companies that are peers to the entity 110. High performers may be identified by industry and/or by other categories or sub-categories. The superior performance engine 103 may use the chart 500 to identify high performers. For example, entities falling in the box 502 shown in FIG. 5 would be high performers. High performers may be identified based on current value and future value. In one embodiment, the superior performance engine 103 calculates the future value benchmark for an industry and calculates future values for companies in the industry. The superior performance engine 103 compares each company's future value to the future value benchmark. If the future value is greater than the future value benchmark, the company is tagged as a high performer for the industry. The tag may be stored in the data storage 120 with other information for the company.

Other criteria or criteria in addition to the criteria described above may be used to determine whether an entity is a high performer. For example, some or all of the following criteria are to be satisfied for an entity to be considered a high performer. One criteria is the enterprise value of the entity outperforms its peers group. For example, the enterprise value is greater than a weighted average of the enterprise value of the peer group. The comparison may be over one or more periods of time and may be a percentage change from the previous period. For example, the enterprise value outperforms its peer group year over year for a predetermined number of years, which may be one or more years. As indicated above, the total market value of a company may be defined as the company's market value of equity plus the market value of the debt, and EV=MV less excess cash. Another criteria is that the stock price increased by more than the peer group. Another criteria is that the market value is greater than the peer group.

Another criteria is that the entity has a positive EP, and another criteria is that the entity has a future value premium. As indicated above, the future value premium is a positive amount of future value greater than the future value benchmark.

At step 802, benchmarks are determined from the factors for the high performers identified at step 801. The benchmarks may be for one or more of the factors in the high performance indices. For example, referring to FIG. 5, benchmarks may be determined for market, competition and regulation low-level factors. These benchmarks may be measurements for metrics or derived from measurements. A benchmark may be determined for the environment intermediate-level factor. This benchmark may be a score. Also, a benchmark may be determined for the high-level factor of growth, which also may be a score. In a simple example, benchmarks may be means or medians calculated by the superior performance engine 103.

At step 803, weights are determined for the factors in the high performance indices. The weights may be based on the impact the factors are determined to have on future value or other performance metrics for the high performers. Regressive modeling and expert analysis of historic data for high performers may be used to determine the weights. The weights may be input into the system 100 by experts. The weights and benchmarks may be determined for different industries or for other categories or sub-categories. Weights and benchmarks may also be determined for each lifecycle stage of the high performers. The benchmarks and weights may be used for benchmarking and optimizing performance of the entity 110 as is described in the method below. The determination of the high performers, benchmarks and weights is an on-going process based on new data captured from the data sources 111. The high performers, benchmarks and weights may thus be modified over time. The high performance indices and their factors are core factors, which may be used across industries. However, all the factors need not be used for determining and optimizing performance.

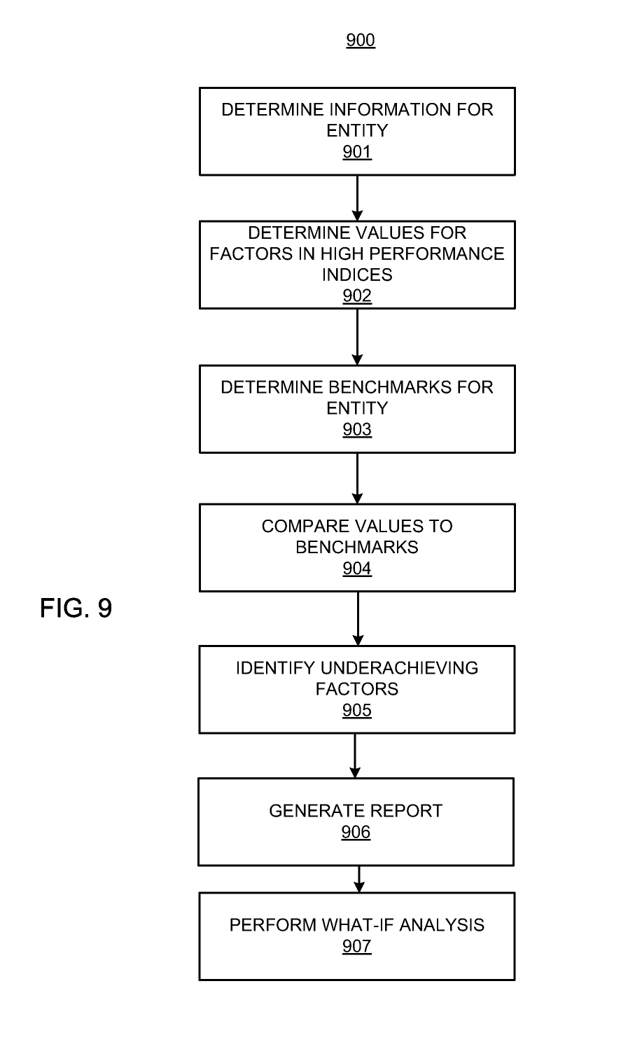

FIG. 9 illustrates a method 900 for benchmarking and conducting “what-if” analysis based on the benchmarking.

At step 901, information for the entity 110 is determined. This may include any information that can be used for benchmarking and optimizing performance of the entity 110. The information may include information identifying the industry or other categories or subcategories for the entity 110. The information may include metrics for the entity 110 used to calculate performance metrics, such as future value. The information metrics may include the entity's measurements for the factors in the high performance indices. The information may be provided to the system 100 via the user interface 101 and/or captured from the data sources 111. The information is stored in the data storage 120.

Other information determined for the entity 110 may include the current stage of the lifecycle for the entity 110. The lifecycle recognition module 106 may estimate the current stage of the lifecycle of the entity 110 by plotting its economic profit and future value over time on the chart 500, such as shown in FIG. 7. Predetermined ranges for economic profit, future value, and growth may be stored in the data storage 120. Each range is associated with a particular stage in the lifecycle. The ranges may vary by industry. The lifecycle stage may be identified by the range the current economic profit, future value, and growth the entity falls into. Additional or other metrics may be used to determine lifecycle stage.

At step 902, values for the factors for the high performance indices are determined for the entity 110 based on the information determined from step 901. The values may be determined by the optimization engine 104 and may be measurements for metrics, values derived from the measurements, or scores derived from measurements or other data. Scores may be based on weights determined for the factors. The weights may be weights corresponding to the current lifecycle stage of the entity 110, the industry of the entity 110 and/or based on other categories. The weights may include weights determined from the step 803 in the method 800.

Also, values may be identified for the factors from the high performance indices determined to be most relevant to the entity 110. Thus, a subset of factors instead of all the factors from the high performance indices may be determined, and values for those factors are determined. The entity 110 or other users may select the subset of factors.

Also, the subset of factors may be selected based on data availability or quality of data. If there is no data or not enough data to calculate values for factors, then those factors are not used in the subset.

At step 903, benchmarks are determined for the entity 110. The benchmarks may include benchmarks determined for the factors for the entity 110.

The benchmarks may include benchmarks corresponding to the current lifecycle stage of the entity 110, the industry of the entity 110 and/or based on other categories. The benchmarks may include benchmarks determined at step 802 of the method 800.

At step 904, the optimization engine 104 compares the values determined at step 902 with the corresponding benchmarks determined at step 903 to determine if the factors for the entity 110 are an improvement over the benchmarks. For each of the values, if the value is not an improvement, the optimization engine 104 tags the factor corresponding to the value as an underachieving factor at step 905; or, if the value is an improvement, the factor for the value is tagged as satisfactory. The tags are stored in the data storage 120.

At step 906, the reporting module 102 generates a report identifying the underachieving factors for the entity 110. The report may be displayed to the entity 110 via the user interface 101.

At step 907, “what-if analysis” is performed to identify business practices to modify to improve performance for the entity 110. This may include calculating estimated performance for the entity based on modifications to underachieving factors. For example, current performance of the entity 110 is calculated. The entity 110 may modify values for one or more of the underachieving factors. The optimization engine 104 can recalculate performance for the entity 110 using the new values and compare it to the current performance to determine whether the modifications improve performance by a predetermined amount. Once a set of modifications are identified, then business practices may be modified so the modifications and ultimately the improved performance can be realized. The performance of the entity 110 including the current performance and the recalculated performance may be determined from performance metrics, such as current value, future value, enterprise value, market value, stock price, economic profit, future value premium, etc.

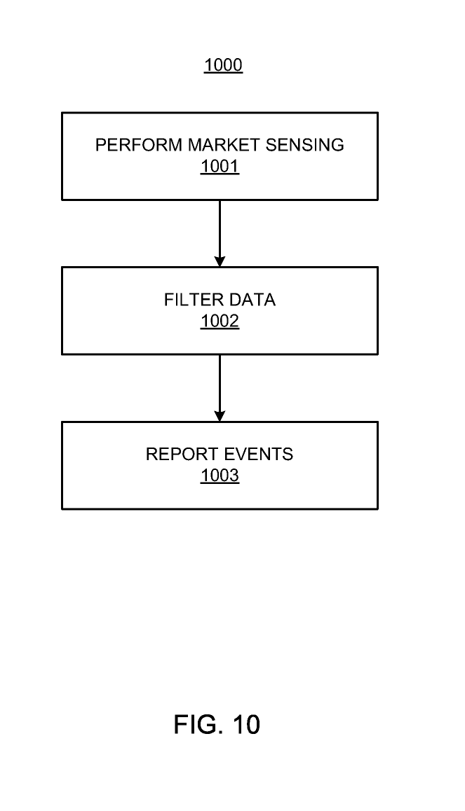

Business performance is increasingly influenced by exogenous factors such as unforeseen market forces, new competitors, regulatory changes, and emerging technologies. According to an embodiment, the system 100 conducts market sensing to identify leading indicators that actions may be required to maintain or improve performance. FIG. 10 illustrates a flowchart of a method 1000 for identifying data most likely to represent events that may impact performance for the entity 110. At step 1001, market sensing is performed. For example, information is gathered that may be related to the entity 110 from the data sources 111. The information may be related to factors in the high performance indices and may include exogenous factors such as unforeseen market forces, new competitors, regulatory changes, and emerging technologies. The competitive opportunities engine 105 may instruct the data capture module 107 to run queries for specific information, such as specific exogenous factors pertinent to the entity 110. The entity 110 may identify the relevant exogenous factors.

The data capture module 107 may capture and normalize the data for use in modeling or other statistical calculations. For example, the data may be captured from unstructured sources such as web blogs, social media sites, geospatial maps, infrared imagery, web cameras, weather maps, and text documents, and converted into a structured format usable in analytical models such as product forecasting, pricing, supply chain optimization, or marketing.

At step 1002, the competitive opportunities engine 105 filters the data from the market sensing performed at step 1001. The filtering identifies the data most likely to represent events that may impact performance for the entity 110. In one example, the filtering may be performed as a combination of evaluating the data source and identifying key words in the data. In other examples, analytical models or artificial intelligence, such as Bloom filters or Bayesian networks, are used to identify the data most likely to represent events that may impact performance for the entity 110.

At step 1003, the data most likely to represent events that may impact performance for the entity 110 is reported for example by the reporting module 102 via the user interface 101 or another channel. The reporting may be sent to appropriate decision makers in a timely fashion so they can take action if appropriate.

7. Computer System

FIG. 11 shows a computer system 1100 that may be used as a hardware platform for the system 100. Computer system 1100 may be used as a platform for executing one or more of the steps, methods, modules and functions described herein that may be embodied as software stored on one or more computer readable mediums. The computer readable mediums may be non-transitory, such as storage devices including hardware.

Computer system 1100 includes a processor 1102 or processing circuitry that may implement or execute software instructions performing some or all of the methods, modules, functions and other steps described herein. Commands and data from processor 1102 are communicated over a communication bus 1106. Computer system 1100 also includes a computer readable storage device 1103, such as random access memory (RAM), where the software and data for processor 1102 may reside during runtime. Storage device 1103 may also include non-volatile data storage. Computer system 1100 may include a network interface 1105 for connecting to a network. It will be apparent to one of ordinary skill in the art that other known electronic components may be added or substituted in computer system 1100. Also, the components of the system 100 may be executed by a distributed computing system. In one example, the system 100 is implemented in a cloud system or other type of distributed computing system.

While the embodiments have been described with reference to embodiments, those skilled in the art will be able to make various modifications to the described embodiments without departing from the scope of the claimed embodiments.

What is claimed is:

1. A performance optimization system comprising:
a superior performance engine identifying high performance entities and determining benchmarks from data captured for the high performance entities, wherein the benchmarks correspond with factors in each of a plurality of indices comprised of a growth index, an operational excellence index, and an enterprise management index;
a data capture module capturing data related to the factors for an entity; and
an optimization engine, executed by a computer system, determining values for the factors from the data captured for the entity; comparing the values with the benchmarks to identify one or more underachieving factors; and
calculating estimated performance for the entity based on modifications to the underachieving factors.

2. The system of claim 1, wherein the optimization engine calculates estimated performance for the entity by calculating current performance of the entity; calculating modified performance for the entity based on the modifications to the underachieving factors; and determining whether the modified performance is an improvement over the current performance.

3. The system of claim 1, wherein the current performance and the modified performance are based on current value and future value for the entity.

4. The system of claim 1, wherein the superior performance engine identifies high performance entities as a function of metrics for peers of the entity.

5. The system of claim 4, wherein the metrics include at least one of future value premium, wherein future value premium is a future value greater than a future value benchmark, positive economic profit, enterprise value, stock price, and market value.

6. The system of claim 5, wherein the future value benchmark equals sum(Peer Group, FV)/sum(Peer Group, IC), and wherein FV is future value and IC is invested capital.

7. The system of claim 5, wherein the future value benchmark is based on a median future values for the peers.

8. The system of claim 1, wherein the growth index comprises a hierarchal index including intermediate factors of environment, offering franchise, and customer factors, wherein low-level factors under environment comprise market, competition and regulation; and low-level factors under customer comprise value, share and loyalty; and low-level factors under offering franchise comprise product equity, brand equity and distribution channel equity.

9. The system of claim 1, wherein the operational excellence index comprises a hierarchal index including intermediate factors comprising supply chain effectiveness, sustainability, health and safety, and product development, wherein low-level factors under supply chain effectiveness comprise delivery service, cost to serve, supply chain risk management, supply chain flexibility, after sales support, and sourcing and procurement; and low-level factors under sustainability comprise carbon footprint, products, and regulatory impacts; and low-level factors under product development comprise new product launch, product launch, and product lifecycle management.

10. The system of claim 1, wherein the enterprise management index comprises a hierarchal index including intermediate factors of strategic management, corporate efficiency and human capital, wherein low-level factors under strategic management comprise corporate structure, performance and risk management, and innovation; and low-level factors under corporate efficiency are associated with efficiency of units in the entity including sales and distribution, information technology, legal, finance, and human resources; and low-level factors of human capital comprise talent, leadership, and culture.

11. The system of claim 1, wherein the superior performance engine determines weights for the factors, wherein the weights are based on impact the factors are determined to have on performance of the high performance entities, and the values for the factors for the entity are determined the values based on the weights.

12. The system of claim 1, comprising:
a competitive opportunities engine identifying data associated with exogenous factors that are operable to impact performance of the entity; filtering the data to identify events operable to impact the performance of the entity; and reporting the identified events to the entity.

13. The system of claim 1, wherein the high performance indices comprise hierarchal indices including one or more of the factors in each level of the hierarchy, and factors in a lower level are used to determine values for factors in a higher level.

14. The system of claim 1, comprising:
a lifecycle recognition module determining a current stage of a lifecycle of the entity based on the data captured for the entity, wherein the estimated performance for the entity is calculated based on the current stage.

15. A method of estimating performance for an entity based on high performance indices, the method comprising:
identifying high performance entities;
determining benchmarks from data captured for the high performance entities, wherein the benchmarks correspond with factors in each of the indices comprised of a growth index, an operational excellence index, and an enterprise management index;
capturing data related to the factors for the entity;
determining values for the factors from the data captured for the entity;
comparing the values with the benchmarks to identify one or more underachieving factors; and
calculating, by a computer system, an estimated performance for the entity based on modifications to the underachieving factors.

16. The method of claim 15, wherein calculating estimated performance for the entity comprises:
calculating current performance of the entity;
calculating modified performance for the entity based on the modifications to the underachieving factors; and
determining whether the modified performance is an improvement over the current performance, wherein the current performance and the modified performance are based on current value and future value for the entity.

17. The method of claim 15, wherein identifying high performance entities comprises:
identifying entities having at least one of a future value greater than a future value benchmark determined from peers in an industry for the entity, a positive economic profit, an enterprise value greater than an enterprise value determined from the peers, a stock price greater than a stock price determined from the peers, and a market value greater than a market value determined from the peers.

18. The method of claim 17, comprising:
calculating the future value benchmark, wherein the future value benchmark equals sum(Peer Group, FV)/sum(Peer Group, IC), and wherein FV is future value and IC is invested capital or equals a median of future values for the peers.

19. The method of claim 15, wherein the growth index comprises a hierarchal index including intermediate factors of environment, offering franchise, and customer factors, wherein low-level factors under environment comprise market, competition and regulation; and low-level factors under customer comprise value, share and loyalty; and low-level factors under offering franchise comprise product equity, brand equity and distribution channel equity;
the operational excellence index comprises a hierarchal index including intermediate factors comprising supply chain effectiveness, sustainability, health and safety, and product development, wherein low-level factors under supply chain effectiveness comprise delivery service, cost to serve, supply chain risk management, supply chain flexibility, after sales support, and sourcing and procurement; and low-level factors under sustainability comprise carbon footprint, products, and regulatory impacts; and low-level factors under product development comprise new product launch, product launch, and product lifecycle management; and
the enterprise management index comprises a hierarchal index including intermediate factors of strategic management, corporate efficiency and human capital, wherein low-level factors under strategic management comprise corporate structure, performance and risk management, and innovation; and low-level factors under corporate efficiency are associated with efficiency of units in the entity including sales and distribution, information technology, legal, finance, and human resources; and low-level factors of human capital comprise talent, leadership, and culture.

20. A non-transitory computer readable medium storing computer readable instructions, that when executed by a computer system, perform a method of estimating performance for an entity based on high performance indices, the method comprising:
identifying high performance entities;
determining benchmarks from data captured for the high performance entities, wherein the benchmarks correspond with factors in each of the indices comprised of a growth index, an operational excellence index, and an enterprise management index;
capturing data related to the factors for the entity;
determining values for the factors from the data captured for the entity;
comparing the values with the benchmarks to identify one or more underachieving factors; and
calculating an estimated performance for the entity based on modifications to the underachieving factors.
